(19) United States
(12) Patent Application Publication
(10) Pub. No.: US 2003/0139536 A1
(43) Pub. Date: Jul. 24, 2003

(54) Heat-reversible polymers with nitroxide functions

(76) Inventors: Denis Bertin, Plan De Cuques (FR); Ludovic Dumont, Elbeuf (FR); Jean-Pierre Lascombe, La Mulatiere (FR); Martin Baumert, Serquigny (FR); Olivier Guerret, Mazerolles (FR); Christian Laurichesse, Bernay (FR)

Correspondence Address: David J Alexander, Fina Technology Inc, PO Box 674412, Houston, TX, 77267-4412, US

(21) Appl. No.: 10/204,879

(22) PCT Filed: Feb. 15, 2001
(86) PCT No.: PCT/FR01/00451

(30) Foreign Application Priority Data
Feb. 23, 2000 (FR) 00/02247

(51) Int. Cl. C08C 19/22

(52) U.S. Cl. 525/377

(57) ABSTRACT

The invention concerns a method for preparing resins branched or crosslinked by heat treatment with a polymer in the presence of a multinitroxide and optionally a free radical initiator, to obtain a resin exhibiting properties of beat reversibility. The initial polymer can be a rubber or a thermoplastic polymer. The resins obtained provide conditions for use similar to those of the initial polymers while exhibiting enhanced mechanical properties.

The invention relates to the preparation of thermoreversible branched or crosslinked resins. In the case of conventional branching or crosslinking of polymers, the branching or crosslinking is irreversible. Once branching or crosslinking has taken place, it is not possible to return to the initial state. The final product therefore has good mechanical properties, but the viscosity of the product is very high. This high viscosity limits the possible ways of using branched or crosslinked resins, except for certain applications like automobile cablemaking in which the irreversible crosslinking takes place during the manufacture of the finished articles.

Resins having improved mechanical properties, while still remaining fluid when hot, are very desirable in many applications. Mention may be made, as examples of polymers, of hot-melts based on EVA (ethylene/vinyl acetate copolymer) or EDA (ethylene/acrylic monomer copolymer, the expression “acrylic monomer” meaning acrylate or methacrylate), EVA-based bitumens, star-shaped styrene-butadiene block copolymers, styrene-butadiene-styrene copolymers (SBS), styrene-isoprene-styrene copolymers (SIS), high-density polyethylenes (HDPE, especially for producing pipes), low-density polyethylenes (LDPE) or linear low-density polyethylenes (LLDPE) (especially for packaging applications) which can be used for producing heat-shrinkable films.

Increasing the yield stress by one or two MPa by crosslinking is regarded by a person skilled in the art as being a considerable increase in the mechanical properties of a resin. A person skilled in the art wishes to increase the mechanical properties by several MPa, even if it entails losing a little of the melt flow compared with non-thermoreversible uncrosslinked resins. This is because excessively fluid resins sometimes leave the extruder too quickly, which is not always satisfactory when converting them, especially into tube or pipe.

The two characteristics—mechanical properties on the one hand and melt flow on the other hand—are, according to the prior art, contradictory because the mechanical properties are favored by a greater length of the macromolecular chains, whereas melt flow is favored by a shorter length of the chains. Depending on the intended applications, it is necessary to find a good compromise between mechanical properties and melt flow, by varying the degree of crosslinking.

The invention makes the branching or crosslinking reversible, thereby resulting in the following phenomena:

at low temperature (for example at room temperature, or 20° C.), the resin has the properties of a branched or crosslinked network, and therefore good mechanical properties;

when hot, the resin recovers good melt flow by at least partial regeneration of the initial unbranched or uncrosslinked chains, and is therefore easy to convert (high melt flow index).

Thus, the resins produced according to the invention have improved low-temperature mechanical properties while maintaining, when hot, good melt flow, the latter facilitating their processing (extrusion, injection molding, and the like). These resins are called thermoreversible resins.

The cold mechanical properties (that is to say the properties at a temperature below the debranching or decrosslinking temperature) of the thermoreversible resins obtained by virtue of the invention exhibit good stability over time. The branching or crosslinking network formed according to the invention is stable over time in the same way as the non-thermoreversible branched or crosslinked networks.

By virtue of the invention, articles such as, for example, tubes and pipes, with well-defined mechanical properties may be manufactured with higher production rates because of the lower viscosity of the resin.

The invention is especially applicable to hot-melt adhesives. A hot-melt adhesive is a formulation which is solid at ordinary temperature and processed in the melt (at around 180° C. approximately), which hardens on cooling and has adhesive properties. A general description of hot-melt adhesives will be found in EP 0 600 767, page 2, lines 5 to 23.

Hot-melt adhesives offer only limited temperature withstand capabilities under load, usually 60-70° C., which precludes them from certain applications in fields such as the automobile, building, packaging, textile, wood-veneering and top-of-the-range bookbinding fields.

The present invention provides an increase in the thermal withstand of an industrial formulation of a hot-melt adhesive. The hot-melt adhesive according to the invention is applicable in the building, automobile, packaging, bookbinding and wood fields.

U.S. Pat. No. 5,506,296 teaches how to increase the thermal withstand of hot-melt adhesives by using moisture-crosslinkable components. That document discloses a hot-melt adhesive composition based on an EVA copolymer and a polyisocyanate, the EVA copolymer being a copolymer having a melt flow index at 190° C. of between 100 and 1000 and containing, with respect to the weight of said copolymer: 1) 60 to 90% ethylene; 2) 10 to 40% vinyl acetate; 3) 5 to 20 meq OH of an unsaturated ethylenic termonomer having at least one primary hydroxyl functional group per mole, said composition containing substantially no free hydroxyl functional group. These compositions have an improved thermal withstand.

French patent application filed under No. 00/02247 discloses the use of multifunctional nitroxide/peroxide mixtures to crosslink polymers in a thermally reversible manner.

EP 348200 teaches how to synthesize ethylene copolymers with aliphatic branching having less than 10 units per 1000 carbon atoms. The use of these polymers gives hot-melts having improved cohesion.

JP 63268782 discloses branched structures which increase the thermal withstand of adhesives.

The present invention allows the production of “one-component” hot-melt adhesives (which means that the adhesive can be processed without a hardener, unlike epoxy adhesives), which offer processability identical to commercial products with, in addition, a substantially improved temperature of flow under load (SAFT test).

Compared with polyurethane-type compositions (the case of U.S. Pat. No. 5,506,296 for example), the invention offers the advantage of not requiring the use of isocyanates (which can entail toxicity problems) and does not pose a pot-life problem.

The multifunctional-nitroxide-modified polymers may also be used in bitumen formulations, which must have a low viscosity when hot (to make them easier to process) and a sufficient hardness when cold (to be able to withstand the loads that they must be able to support). The present invention also provides an increase in the hardness of the polymers.

The invention involves the heat treatment of a polymer in the presence of a multifunctional nitroxide (an organic molecule carrying at least two free nitroxide groups, that is to say at least two .O−N═ groups) and preferably a free-radical initiator, so as to obtain a resin exhibiting the property of thermoreversibility. The starting polymer may be a rubber or thermoplastic polymer. Within the context of the present invention, the term “rubber” denotes a polymer whose tensile modulus as measured by the ISO 178 standard is less than 1×10⁷ Pa. Within the context of the present invention, a “thermoplastic polymer” denotes a polymer whose tensile modulus as measured by the ISO 178 standard is greater than 1×10⁷ Pa. For the case in which a rubber is used, the resin obtained after heat treatment generally continues to have a tensile modulus of less than 1×10⁷ Pa. Of course, if the polymer before heat treatment is a thermoplastic polymer and consequently has a tensile strength greater than 1×10⁷ Pa, it also has a tensile modulus greater than 1×10⁷ Pa after the heat treatment. In the case of polymers that have undergone a treatment in order to branch or crosslink it thermoreversibly, these moduli are, of course, measured on the resin in the branched or crosslinked state.

Cases of thermoreversible crosslinking according to the prior art involve a chemical reaction between acid functional groups (provided by anhydrides, such as maleic anhydride: a monomer grafted onto polyolefins by means of radicals) and alcohol functional groups, in order to form a ester functional group which is thermoreversible. Thus, JP 11106578 discloses a polyolefin modified by an acid anhydride and brought into contact with alcohols, such as 2,5-hexanediol. EP 870 793 discloses a blend of a first polymer possessing at least two acid functional groups with a second polymer possessing at least two amine functional groups so as to form amide groups. The article published in the Japanese journal “Chemical Daily”, No. 19119, front page, March 1999, the author of which is Dr. Hoshino, reports the development by Mitsubishi Chemical of resins crosslinked thermoreversibly by a chemical route, namely “TRC polymers”. These polymers form a covalent bond which is stable at low temperature but can dissociate at high temperature (above 150° C.).

The prior art relating to thermoreversible polymers always involves amide or ester functional groups in the thermoreversible resin. The thermoreversibility according to the prior art is always based on the equilibrium of one of the following reactions:

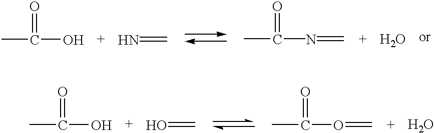

the resin therefore always crosslinking in this case by the formation of amide or ester functional groups and water.

The grafting of a monofunctional nitroxide onto a polymer chain resulting in a ≡C—O—N═ linking group is taught by U.S. Pat. No. 4,581,429. EP 903 354 teaches how to prepare, in a solvent, a rubber carrying a stable free radical that may be difunctional. Patent application WO 00/55211 teaches how to prepare, in an extruder, a rubber carrying a stable free radical which may be difunctional. These documents do not disclose thermoreversible resins.

Radical polymerization processes carried out in the presence of multifunctional alkoxyamines (and not multifunctional nitroxides), releasing mononitroxides for the preparation of star polymers, are disclosed in U.S. Pat. No. 5,627,248 and U.S. Pat. No. 5,498,679. In these documents, the multifunctional initiator divides into several fragments at the start of the reaction, so that in fact it is the multifunctional nitroxides which come into play in the rest of the reaction.

Chenming Li et al., Macromolecules 1999, 32, 7012-7014 describe the polymerization of styrene in the presence of a mononitroxide carrying a vinyl group. In this way, the nitroxide is copolymerized with the styrene. In that process, the nitroxide comonomer is in very low concentration, resulting in one or two molecules per chain in the final polymer. In addition, the initiator in the polymerization mixture merely has the role of initiating the polymerization and not of grafting .O—N═ onto a hydrocarbon chain. This is because the free-radical initiator is in a monomer-rich mixture, and on account of the fact that the reaction of an initiator with the monomer to cause polymerization is much more rapid than the reaction of extracting a proton from a carbon, the initiator can in no case extract protons from a mixture so rich in monomer. The nitroxide functional groups may from time to time become attached during polymerization to the ends of the growing polymer chain, but cannot become grafted onto carbons located within the polymer chains. Thus, in that document, the oxygen atoms of the nitroxide functional groups, if they are linked to carbon atoms of the polymer chain, can only be linked to carbon atoms located at the end of a chain. In that document, the final polystyrene is thus partially branched, but not crosslinked. This polymer may be regarded as a linear chain. Heating to a temperature at which the C—O bonds break has very little influence on the polydispersity index and therefore consequently on the change in number-average molecular weight. Additionally, the process in that document is applicable in practice only to styrene since the nitroxide comonomer is unstable under the conditions for polymerizing other monomers, such as ethylene, or therefore inhibits, practically completely, the polymerization of other monomers such as acrylates or methacrylates.

Patent application WO 00/63260 discloses the peroxide degradation of polypropylene-based compositions in the presence of a nitroxide. A difunctional nitroxide is cited in the descriptive part of that application.

The invention provides a simple and economic solution to the manufacture of resins with improved mechanical and melt-flow properties by treating standard commercial resins in the presence of a multifunctional nitroxide and, preferably, of a free-radical initiator. This synthesis process is simple since it is unnecessary to modify and/or synthesize novel resins in order to provide the suitable functional groups. In particular, the invention allows thermoreversible resins to be produced without it being necessary for amide or ester functional groups to form within it.

The process for converting the final resin is identical to that of the initial polymer insofar as the processing temperature is high enough to produce sufficient debranching or decrosslinking.

The process according to the invention involves a step comprising a heat treatment of a polymer so as to extract protons from the polymer chain, and in the presence of a multifunctional nitroxide. If the polymer lends itself thereto, simply heating the polymer in the presence of the multifunctional nitroxide may suffice; this is in particular the case with olefin polymers, such as ethylene polymers. However, in all cases, the presence of a free-radical initiator, promoting the extraction of protons from the polymer chain, is also preferred.

The invention involves the multifunctional nitroxide and, where appropriate, the free-radical initiator in order to form the linking group:

≡X—O—N═ (1)

by extraction of the hydrogen atom which was initially linked to the X atom of said linking group. The X atom forms part of a polymer chain. Generally, X is a carbon atom, but it may also be a sulfur or phosphorus atom. Preferably, X is a carbon atom. Thus, the atoms contributing to the formation of the thermoreversible bonds and forming part of the main chains of the polymer may be carbon or sulfur or phosphorus atoms.

The characteristic of the linking group (1) is that the X—O covalent bond is thermally reversible in order to re-form two radical species, ≡X. on the one hand and .O—N═ on the other. The reaction leading to the structure of formula (1) may be carried out in an extruder during an extrusion, a standard operation for processing polymers, and therefore with reaction times of between 30 seconds and 10 min. This reaction may also be carried out in a reactor with as short or longer reaction times. Within the context of the present invention, it is unnecessary to have recourse to oven curing, as in the case of “TRC polymers”.

The resins obtained by the process according to the invention offer processing (i.e. conversion, such as injection molding) conditions similar to those for the initial polymers (before the grafting to form the linkages of type (1)), while improving the mechanical properties such as the yield stress (in tension) and generally the tear strength and the impact behavior.

Within the context of the present invention, the term “polymer” has its most general meaning, that is to say it encompasses the notions of copolymer, interpolymer, terpolymer, polymer blend and composition comprising at least one polymer. The polymer undergoing the heat treatment generally has a number-average molecular weight (Mₙ) ranging from 1 000 g/mol to 500 000 g/mol and preferably ranging from 5 000 to 300 000 g/mol. The above values characterize the polymer before the heat treatment and also characterize the resin obtained after the heat treatment, but in the state of debranching or decrosslinking, that is to say at a temperature at which the X—O bonds have dissociated.

The process according to the invention is applicable to all radical-sensitive polymers: these may be defined by macromolecular chains possessing at least one labile atom, this atom being preferably a hydrogen atom, which is linked to an X atom, the latter generally being a carbon atom, but which may also be a sulfur or phosphorus atom. Preferably, polymers for which hydrogen extraction is followed by crosslinking are used. As radical-sensitive polymers, mention may be made of polyolefins such as ethylene polymers (preferably containing at least 5% by weight of ethylene) such as polyethylene, copolymers based on olefin monomers, especially ethylene, such as VLDPE, LLDPE, EPR and EPDM, ethylene-vinyl acetate copolymers (called EVAs), EVOHs, ethylene-butyl acrylate copolymers, ethylene-methyl acrylate copolymers, ethylene-2-ethylhexyl acrylate copolymers, terpolymers such as those of the ethylene-acrylate-maleic anhydride or ethylene-acrylate-glycidyl methacrylate (for example LOTADER®) type, poly(meth)acrylates, polyvinyl chloride (PVC), polyvinyls and all derived copolymers, such as block copolymers and graft copolymers having at least one generally hydrocarbon macromolecular chain described above. Mention may also be made, as polymers, of butadiene/isoprene copolymers, SIS (styrene-isoprene-styrene) copolymers, SEBS, SBS and SB copolymers, polyesters and polyamides.

As an example, it is possible to use, as polymer, polymers of vinyl, vinylidene, diene, olefin and allyl monomers.

The expression “vinyl monomers” is understood to mean (meth)acrylates, vinyl aromatic monomers, vinyl esters, (meth)acrylonitrile, (meth)acrylamide and monoalkyl and dialkyl (meth)acrylamides (the alkyl containing 1 to 18 carbon atoms) and monoesters and diesters of maleic anhydride and maleic acid.

The (meth)acrylates are in particular those of the formulae, respectively:

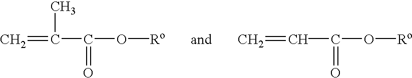

in which R^{o} is chosen from linear or branched, primary, secondary or tertiary, alkyl radicals containing 1 to 18 carbon atoms, cycloalkyl radicals containing 5 to 18 carbon atoms, alkoxyalkyl radicals (the alkoxy containing 1 to 18 carbon atoms and the alkyl 1 to 18 carbon atoms), alkylthioalkyl radicals (the alkylthio containing 1 to 18 carbon atoms and the alkyl 1 to 18 carbon atoms), aryl radicals and arylalkyl radicals, these radicals being optionally substituted with at least one halogen atom (such as fluorine) and/or at least one hydroxyl group after protection of this hydroxyl group, the above alkyl groups being linear or branched; and glycidyl, norbornyl and isobornyl (meth)acrylates. As examples of useful methacrylates, mention may be made of methyl, ethyl, 2,2,2-trifluoroethyl, n-propyl, isopropyl, n-butyl, sec-butyl, tert-butyl, n-amyl, isoamyl, n-hexyl, 2-ethylhexyl, cyclohexyl, octyl, isooctyl, nonyl, decyl, lauryl, stearyl, phenyl, benzyl, β-hydroxyethyl, isobornyl, hydroxypropyl and hydroxybutyl methacrylates.

As examples of acrylates of the above formula, mention may be made of methyl, ethyl, n-propyl, isopropyl, n-butyl, sec-butyl, tert-butyl, hexyl, 2-ethylhexyl, isooctyl, 3,3,5-trimethylhexyl, nonyl, isodecyl, lauryl, octadecyl, cyclohexyl, phenyl, methoxymethyl, methoxyethyl, ethoxymethyl and ethoxyethyl acrylates.

As vinyl esters, mention may be made of vinyl acetate, vinyl propionate, vinyl chloride and vinyl fluoride.

As vinylidene monomer, mention may be made of vinylidene fluoride.

The expression “diene monomer” is understood to mean a diene chosen from linear or cyclic, conjugated or unconjugated dienes such as, for example, butadiene, 2,3-dimethylbutadiene, isoprene, 1,3-pentadiene, 1,4-pentadiene, 1,4-hexadiene, 1,5-hexadiene, 1,9-deca-diene, 5-methylene-2-norbornene, 5-vinyl-2-norbornene, 2-alkyl-2,5-norbornadienes, 5-ethylene-2-norbornene, 5-(2-propenyl)-2-norbornene, 5-(5-hexenyl)-2-norbornene, 1,5-cyclooctadiene, bicyclo[2.2.2]octa-2,5-diene, cyclopentadiene, 4,7,8,9-tetrahydroindene and isopropylidene tetrahydroindene.

As olefin monomers, mention may be made of ethylene, butene, hexene and 1-octene. Fluorinated olefin momoners may also be mentioned. Mention may also be made, as starting monomers for the polymer, of vinyl ethers, ketenes, aldehydes and ketones.

It is also possible to use, as polymer, one of the following block copolymers:

polystyrene-b-polymethyl methacrylate;

polystyrene-b-polyacrylamide;

polystyrene-b-polymethacrylamide;

polymethyl methacrylate-b-polyethyl acrylate;

polystyrene-b-polybutyl acrylate;

polybutadiene-b-polymethyl methacrylate;

polyisoprene-b-polystyrene-co-acrylonitrile;

polybutadiene-b-polystyrene-co-acrylonitrile polystyrene-co-butyl acrylate-b-polymethyl methacrylate;

polystyrene-b-polyvinyl acetate;

polystyrene-b-poly(2-hexylethyl) acrylate;

polystyrene-b-poly(methyl methacrylate-co-hydroxyethyl acrylate);

polystyrene-b-polybutadiene-b-polymethyl methacrylate;

polybutadiene-b-polystyrene-b-polymethyl methacrylate;

polystyrene-b-polybutyl acrylate-b-polystyrene;

polystyrene-b-polybutadiene-b-polystyrene;

polystyrene-b-polyisoprene-b-polystyrene;

poly(perfluorooctyl)acrylate-b-polymethyl methacrylate;

poly(perfluorooctyl) acrylate-b-polystyrene;

poly(perfluorooctyl) acrylate-b-polystearyl methacrylate;

poly(n-octyl)acrylate-b-polymethyl methacrylate.

Within the context of the present invention, the polymer preferably contains at least 5% by weight of at least one of the following monomers: ethylene, butadiene, isoprene, butene and 1-octene.

The free-radical initiator is capable of extracting hydrogen atoms from the polymers used. To be able to extract protons from the polymer chain, the reaction mixture must allow this and must therefore be in a sufficiently low monomer concentration for the initiator to be able to fulfill its role with respect to the polymer chains. This is because, in the presence of monomer, the initiator preferentially initiates the polymerization of the monomer. It is therefore consumed by the reaction with the monomer and therefore cannot extract the protons. This is why the reaction during the heat treatment is preferably carried out in the absence of monomer, or in the presence of a low proportion of residual monomer, that is to say less than 200 ppm of residual monomer. In all cases, the monomer must be in sufficiently low concentration not to prevent proton extraction from the polymer chain. It is in this sense that the heat treatment may be referred to as being preferably carried out in the absence of polymerization reactions.

The amounts of multifunctional nitroxide and, where appropriate, of initiator to be employed may vary depending on the functionality of the multifunctional nitroxide and the functionality of the initiator. They must be employed in the heat treatment in sufficient amount so that the final resin is indeed thermoreversible.

The multifunctional nitroxide and, where appropriate, the free-radical initiator are generally each present in an amount from 10 ppm by weight to 20% by weight and preferably from 100 ppm to 5% by weight with respect to the weight of the initial polymer to be modified.

If we denote:

f_{A} as the functionality of the free-radical initiator, that is to say the number of moles of free radicals that each mole of initiator generates;

n_{A} as the number of moles of free-radical initiator;

f_{SFR} as the functionality of the nitroxide, that is to say the number of .O—N═ groups that the nitroxide contains; and

n_{SFR} as the number of moles of nitroxide; then the nitroxide and the free-radical initiator are generally used in an amount such that (f_{A}n_{A}/f_{SFR}n_{SFR}) is between 0.001 and 30, preferably between 0.01 and 10 and even more preferably between 0.1 and 5.

This heat treatment step may be carried out in high-shear machines, such as conventional tools for converting plastics, like single-screw, twin-screw corotating and/or counterrotating extruders, co-kneaders (for example a Buss® co-kneader) and internal mixers. This allows a large number of polymers to be used: thermoplastic resins, rubbers and resins having a complex structure such as block copolymers and/or graft copolymers. Because of the high shear that the abovementioned machines allow, it is unnecessary to add a solvent in order to carry out the heat treatment step, this providing the advantage of not having to remove the solvent thereafter. Generally, the heat treatment may be carried out at a temperature ranging from 50 to 250° C.

If the heat treatment is carried out in the absence of solvent or in the presence of a little solvent (less than 10% by weight with respect to the polymer to be treated), the heat treatment may be carried out on the polymer in the melt at the temperature that one would chose simply to convert it. Usually, ethylene polymers are converted between 120 and 220° C. and more generally between 180 and 220° C. Some ethylene copolymers, such as EVA and EDA, are converted between 120 and 200° C.

In general, if these conditions are applied (i.e. no or less than 10% by weight of solvent and polymer in the melt), the heat treatment may be carried out between 180 and 250° C., within which temperature range the thermoplastic polymers envisioned by the present invention will generally be in the melt.

Of course, to carry out this heat treatment, the presence of a solvent is not excluded. In this case a solvent for the polymer to be treated is chosen. The chemical reaction of the heat treatment may be carried out in any suitable chemical reactor. Under these conditions, and provided that the reaction mixture is sufficiently liquid, the heat treatment may in general be performed between 50 and 150° C.

The free-radical initiator may be chosen from azo compounds and organic peroxides and hydroperoxides. Preferably, the free-radical initiator may be chosen from peresters, alkyl peroxides, acyl peroxides, percarbonates and peracetals. Preferably, the free-radical initiator must be chosen so that it can improve the extraction of hydrogen atoms from the base polymers. As an example, the free-radical initiator may be chosen from the following list:

benzoyl peroxide;

lauroyl peroxide;

decanoyl peroxide

3,5,5-trimethylhexanoyl peroxide;

acetyl cyclohexylsulfonyl peroxide;

tert-butyl peroxybenzoate;

tert-butyl peroxyacetate;

tert-butyl peroxy-3,5,5-trimethylhexanoate;

tert-amyl peroxy-3,5,5-trimethylhexanoate;

2,5-dimethyl-2,5-di(benzoylperoxy)hexane;

OO-tert-butyl-O-isopropylmonoperoxy carbonate;

OO-tert-butyl-O-(2-ethylhexyl)monoperoxy carbonate;

OO-tert-amyl-O-(2-ethylhexyl)monoperoxy carbonate;

tert-butyl peroxyisobutyrate;

tert-butyl peroxy-2-ethylhexanoate;

tert-amyl peroxy-2-ethylhexanoate;

2,5-dimethyl-2,5-di(2-ethylhexanoylperoxy)hexane;

tert-butyl peroxypivalate;

tert-amyl peroxypivalate;

tert-butyl peroxyneodecanoate;

tert-butyl peroxyisononanoate;

tert-amyl peroxyneodecanoate;

α-cumyl peroxyneodecanoate;

3-hydroxy-1,1-dimethylbutylperoxyneodecanoate;

tert-butyl peroxymaleate;

ethyl 3,3-di(tert-butylperoxy)butyrate;

ethyl 3,3-di(tert-amylperoxy)butyrate;

n-butyl 4,4-di(tert-butylperoxy)valerate;

2,2-di(tert-butylperoxy)butane;

1,1-di(tert-butylperoxy)cyclohexane;

1,1-di(tert-butylperoxy)cyclohexane;

1,1-di(tert-butylperoxy)-3,3,5-trimethylcyclohexane;

1,1-di(tert-amylperoxy)cyclohexane;

2,2-bis(4,⁴-ditert-butylperoxycyclohexyl)propane;

2,5-dimethyl-2,5-di(tert-butylperoxy)hex-3-yne;

di(tert-butyl) peroxide;

di(tert-amyl) peroxide;

tert-butyl cumyl peroxide;

1,3-di(tert-butylperoxyisopropyl)benzene;

2,5-dimethyl-2,5-di(tert-butylperoxy)hexane;

1,1,4,4,7,7-hexamethylcyclo-4,7-diperoxynonane;

3,3,6,6,9,9-hexamethylcyclo-1,2,4,5-tetra oxanonane;

tert-butyl hydroperoxide;

tert-amyl hydroperoxide;

cumyl hydroperoxide;

2,5-dimethyl-2,5-di(hydroperoxy)hexane;

diisopropylbenzene monohydroperoxide;

paramenthane hydroperoxide;

di(2-ethylhexyl)peroxydicarbonate;

di(cyclohexyl)peroxydicarbonate;

2,2′-azo-di(2-acetoxypropane);

2,2′-azobis(isobutyronitrile);

2,2′-azobis(2,4-dimethylvaleronitrile);

2,2′-azobis(cyclohexanenitrile);

2,2′-azobis(2-methylbutyronitrile);

2,2′-azobis(2,4-dimethyl-4-methoxyvaleronitrile);

3-phenyl-3-tert-butylperoxyphthalide;

3,6,9-triethyl-3,3,9-trimethyl-1,4,7-triperoxonane;

1,4-di(2-tert-butylperoxyisopropyl) benzene;

dicumyl peroxide, di(tert-butyl) peroxide and 2,5-dimethyl-2-di(tert-butylperoxy)hexane being particularly suitable.

The free-radical initiator is chosen according to the temperature selected for the heat treatment, Preferably, the free-radical initiator has a half-life ranging from 1 second to 5 min at the temperature of the heat treatment.

The use of the term “multifunctional” in “multifunctional nitroxide” means that the latter contains at least two nitroxide functional groups.

The multifunctional nitroxide may have a functionality ranging from 2 to 50. The multifunctional nitroxide preferably has a functionality of at least 3. The multifunctional nitroxide more preferably has a functionality of at least 4. Preferably the multifunctional nitroxide has a functionality of at most 15.

As multifunctional nitroxides having a functionality of 2, mention may be made of bis(2,2,6,6-tetramethyl-4-piperidinyloxy)sebacate. Multifunctional nitroxides whose functionality is greater than 4 are preferred. Oxidized CHIMASSORB 944 is a multifunctional nitroxide particularly suitable for the invention.

A trifunctional nitroxide may, for example, be produced by the condensation of three molecules of 4-hydroxy-2,2,6,6-tetramethyl piperidinoxyl on an acid trichloride (cf. Toda et al., ACS Symposium, Series 280, edited by Klemchuck; Am. Chem. Soc., Washington, 1985), according to the following reaction process:

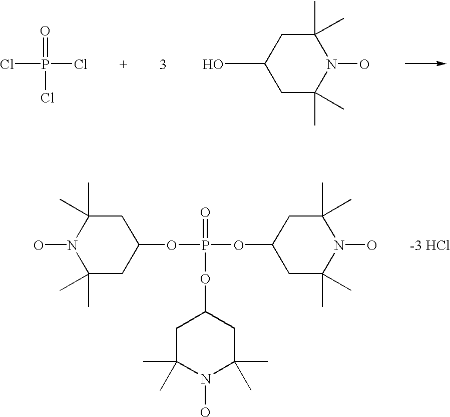

A multifunctional nitroxide may be produced by oxidizing a HALS (a hindered amine light stabilizer) possessing several amine functional groups.

As multifunctional nitroxide, it is possible to use that represented by the following formula:

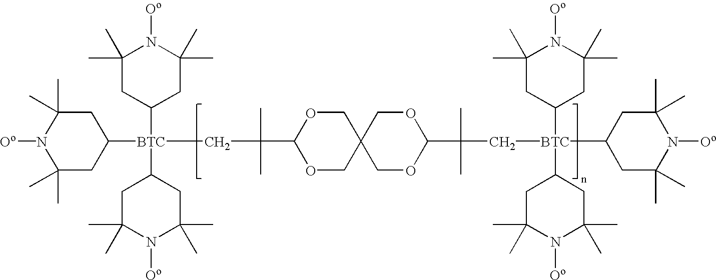

in which BTC is

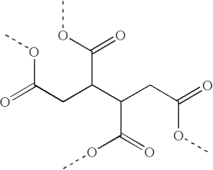

n being on average equal to 1.5.

The multifunctional nitroxide preferably has a number-average molecular weight of less than 5 000 g/mol.

As multifunctional nitroxide, it is possible to use those described in patent application WO 00/40550. The multifunctional nitroxide may not be a monomer and may not include a carbon-carbon double bond. Under these conditions, the multifunctional nitroxide is in general linked to the initial polymer only via ≡X—O—N═ linking groups, X forming part of the polymer. In general, the multifunctional nitroxide is formed in situ during polymerization of the polymer. The multifunctional nitroxide forms a core, the structure of which may possibly not include a polymerized chain of the same nature as those contained in the polymer. The core is the assembly of atoms initially forming the multifunctional nitroxide and the structure and mass of which generally do not change during the heat treatment. The core may therefore possibly not include a polymerized styrene unit. The nitroxide functional groups of the initial multifunctional nitroxide define branching or crosslinking cores, said cores having the same number of nitroxide functional groups as the initial multifunctional nitroxide when the resin is in the debranched or decrosslinked state.

The modified polymers may then be processed by the same conversion machines as those used for the heat treatment in the presence of the multifunctional nitroxide and of the free-radical initiator, or by conversion tools such as injection-molding machines, tube extruders and extrusion-blow molding machines, in order to end up with the finished articles.

In general, the debranching or decrosslinking temperature, that is to say the temperature at which the X—O bonds characteristic of the branching or of the crosslinking network start to undergo significant scission in order to form X. on the one hand and .O—N═ on the other, is generally above 50° C. By modifying the temperature above 50° C., the equilibrium of the reaction:

≡X—O—N═B≡X.+.O—N═

is varied. This equilibrium is shifted to the right when the temperature is increased.

Usually, in the nonthermoreversible resins of the prior art, when a species of the ≡X. type forms on a polymer chain, said species is unstable and immediately disappears. In the case of the thermoreversible resins of the present invention, the .O—N═ functional groups react with the X. functional groups before they disappear to form the ≡X—O—N═ group again, the latter still being able to be split into the two radical species .O—N═ and ≡X.. This mechanism allows the existence, on average, of a high concentration of .O—N═ and ≡X. radicals in the resin in the debranched or decrosslinked state. The ability of the resin to undergo debranching or decrosslinking to a greater or lesser extent may vary depending on the nature of the multifunctional nitroxide and of the initial polymer. In particular, for a given polymer, if the nitrogen atoms of the .O—N═ nitroxide groups form part of a ring in which the other atoms are carbon atoms, the debranching or decrosslinking temperature is generally higher if the ring contains 5 carbon atoms compared with the situation in which the ring would have 6 atoms.

The invention makes it possible to obtain lightly branched or highly branched, or even crosslinked, resins, recognizing the fact that the term “crosslinked” can be likened to an extremely branched state. A polymer is all the more branched when it is difficult (compared with a polymer of the same type) to dissolve in solvents, for example in trichlorobenzene. A polymer is all the more crosslinked when its modulus or its hardness is high (compared with a polymer of the same type). A completely crosslinked polymer is insoluble in any solvent. Thus, the degree of branching or crosslinking of the final resin may be modulated by varying the parameters of the process according to the invention. In particular, the branching or crosslinking may be increased by:

increasing the temperature of the heat treatment,

increasing the amount of multifunctional nitroxide and free radical intiator;

increasing the functionality of the multifunctional nitroxide; and

choosing a free-radical initiator with a higher proton extraction capability.

The invention makes it possible in particular to obtain resins crosslinked cold, which in the crosslinked state have on average 0.1 to 5 crosslinks per polymer chain. Of course, the degree of crosslinking depends on the nitroxides used and on their relative amount with respect to the initial polymer. To do this, the multifunctional nitroxide and the free-radical initiator are employed in a sufficient amount during the heat treatment so that the resin has on average 0.1 to 5 thermoreversible crosslinks per polymer chain.

The heat treatment according to the invention results in the grafting of the nitroxide functional groups of the multifunctional nitroxide onto X atoms of the polymer that is used and is desired to be made thermoreversible, the meaning of X being the same as already given, so as to form ≡X—O—N═ linking groups. In general, the X atoms in question are at least partly attached randomly within the main chain, since the chain ends are generally less reactive during said treatment. In particular, the free-radical initiators generally preferentially extract the labile atoms located on the X atoms within the chains (for example the protons of —CH₂— linking groups) compared with the labile atoms located on chain-end X atoms (for example the protons of —CH₃ linking groups). The process according to the invention may result in the grafting of nitroxide functional groups at the chain ends, but then nitroxide functional groups are necessarily also grafted at other points, such as within the polymer chains. Thus it may be stated that the resin obtained according to the invention cannot undergo debranching or decrosslinking exclusively by the scission of C—O bonds forming part of ≡C—O—N═ linking groups the carbon atom of which belongs to a styrene unit placed at one end of the polymer chain. Thus, the invention also relates to a thermoreversible resin whose thermoreversible bonds are, at least in part, X—O bonds forming part of ≡X—O—N═ linking groups when the resin is in the branched or crosslinked state, X representing an atom of a polymer chain, said resin not debranching or decrosslinking exclusively by scission of C—O bonds forming part of ≡C—O—N═ linking groups the carbon atom of which belongs to a styrene unit placed at one end of the polymer chain.

Thus, the process according to the invention is also a process for manufacturing a thermoreversible resin by the heat treatment of a polymer in the presence of a multifunctional nitroxide and, when appropriate, a free-radical initiator, said initiator extracting protons linked to atoms located within the main chains of the polymer so as to graft in their place the nitroxide functional groups of the multifunctional nitroxide in order to form thermoreversible bonds between said atoms and the oxygen atoms of said nitroxide functional groups. The invention also relates to a thermoreversible resin whose thermoreversible bonds are, at least in part, X—O bonds forming part of ≡X—O—N═ linking groups when the resin is in the branched or crosslinked state, X representing an atom of a polymer chain, the oxygen and nitrogen atoms of said linking groups forming nitroxide functional groups when the resin is in the debranched or decrosslinked state and said nitroxide functional groups defining branching or crosslinking cores not containing a polymerized styrene unit.

The multifunctional nitroxide used at the start forms a branching or crosslinking core within the final resin. This core preferably has a number-average molecular weight of less than 5 000 g/mol.

The invention also relates to a thermoreversible resin whose thermoreversible bonds are, at least in part, X—O bonds forming part of ≡X—O—N═ linking groups when the resin is in the branched or crosslinked state, X having the meaning already given and representing an atom inserted into a main chain of a polymer. The thermoreversible resin according to the invention may possibly not be branched or crosslinked by the formation of amide or ester functional groups and water.

The invention is applicable to hot-melt adhesives. The hot-melt composition according to the invention comprises a thermoreversible resin according to the invention derived from a polymer, the latter possibly being any polymer generally used as a base polymer in hot-melt adhesives. The hot-melt adhesive composition according to the invention also generally includes at least one tackifying resin and may also include at least one wax, at least one plasticizer, at least one filler, such as a pigment (for example TiO₂), and at least one stabilizer.

The polymer (which in what follows will be referred to as the “base polymer”) used within the context of the preparation of the thermoreversible resin forming part of the hot-melt adhesive composition is generally chosen from the following list: an ethylene-acrylate copolymer, an ethylene-vinyl acetate copolymer, a styrene-isoprene-styrene copolymer, a styrene-butadiene-styrene copolymer, a metallocene polyethylene. As base polymer, it is preferred to use an ethylene-acrylate monomer copolymer (the monomer being such as methyl acrylate, ethyl acrylate, butyl acrylate or 2-ethylhexyl acrylate) and/or an ethylene/vinyl acetate copolymer. In this case, the amount of acrylate or vinyl acetate comonomer will generally be from 10 to 45% by weight. In general, the tackifying resin/polymer weight ratio varies from 0 to 3.

The tackifying resin may be of natural origin (a rosin derivative) or of synthetic origin of the aliphatic, aromatic or aromatic/aliphatic hydrocarbon type. The tackifying resin may be a natural or synthetic terpene resin.

The heat treatment according to the invention resulting in the thermoreversible grafting of the multifunctional nitroxide may be applied to the polymer before the latter is introduced into the adhesive composition, or after it has been mixed with the other ingredients (tackifying resin, wax, plasticizer, filler, stabilizer, etc.) of the adhesive composition, in which case the branching or crosslinking takes place in situ during preparation of the final adhesive composition.

The base polymer generally possesses a melt flow index (DIN 537354) at 190° C./2.16 kg of between 2 and 10 000 g/10 min and preferably between 2 and 2 000 g/10 min.

The invention allows the production of a “one-component” hot-melt adhesive composition, offering good processability and a high flow-under-load temperature determined by the SAFT test (ASTM D4498 standard).

The SAFT test is a test measuring the maximum temperature that an adhesive joint can withstand under a given static load. The test is carried out in the following manner:

adhesive is deposited at about 150° C. on a first test piece made of cardboard, having dimensions of 150×25 mm, and then a second test piece, identical to the first, is then applied immediately. The bonding area thus obtained is 25×25=625 mm². The test pieces are left to cool for a minimum of 4 h in an air-conditioned room at 23° C. and 50% relative humidity.

The bonded assembly is then suspended vertically in an oven via the first test piece, the second test piece being loaded with a mass of 500 g, and then subjected to a temperature rise from 25° C. to 200° C. at a rate of 0.4° C./min. The SAFT resistance is the temperature at which the assembly fails (separation of the test pieces from each other).

In Examples 1 to 8 which follow, the following techniques were used:

yield stress (in tension at 23° C.): ISO 178 standard;

melt flow index (at 190° C./2.16 kg): ISO 1133H standard;

creep: ISO 899-1:93 standard. The creep tests were carried out at 23° C. The dumb-bell shaped test pieces were cut from compression-molded plaques of the various polyethylenes. The shape of the test pieces is defined in the ISO 527-2:93-1B standard. weights were suspended from the test pieces and the nominal stress was defined by the weight divided by the initial cross section of the test piece. The strain was measured using a mechanical extensometer up to failure. The failure time was recorded. Creep rupture curves could thus be obtained. The nominal stress was represented therein as a function of the time to failure on a log-log plot. This curve is in general a straight line and can be used to extrapolate to long times (for example 50 years), allowing the aging resistance of the material to be determined.

In the examples which follow, the following abbreviations are used:

DHBP: 2,5-bis(tert-butylperoxy)-2,5-dimethylhexane of developed formula:

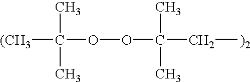

This free-radical initiator has a functionality f_{A} of 4 and a molar mass of 290.

In Examples 1 to 8, the following ingredients were used:

metallocene polyethylene of the ENGAGE 8200 brand from Dow;

high-density polyethylene (HDPE) 2070 ML60 from Aspell;

high-density polyethylene (HDPE) 2004 TN52 from Aspell;

a polyamine of CHIMASSORB 944 brand sold by Ciba-Geigy and satisfying the formula:

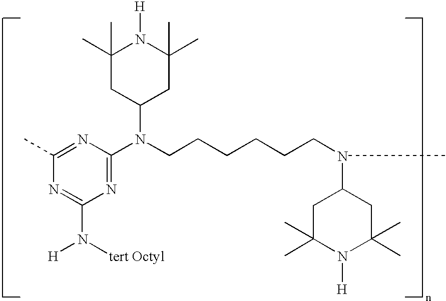

with n ranging from 2 to 3. This amine has a number-average molecular weight of about 3 000 g/mol.

Examples 9 to 13 illustrate the application of the present invention to the field of hot-melt adhesives. In all these Examples 9 to 13, LOTRYL 35BA320 is used as base polymer, this being an ethylene-butyl acrylate copolymer containing 35t butyl acrylate and having a melt flow index at 190° C./2.16 kg of 320 g/10 min (according to the DIN 537354 standard). The peroxide used is dicumyl peroxide sold under the brand LUPEROX DC by Atofina.

### EXAMPLE 1

### Synthesis of a Multifunctional Nitroxide 1

302 g of a polyamine of CHIMASSORB 944® brand sold by Ciba-Geigy was dissolved in three times its weight of dichloromethane, i.e. 906 g, in a 4-liter jacketed reactor fitted with a pH meter probe, a condenser and two dropping funnels. 100 g of water were then added and vigorous stirring of the solution maintained.

The temperature of the solution was taken to 8° C. The initial pH of the aqueous phase was 10.8. 661 g of 40% peracetic acid (i.e. 2 equivalents of oxidizer per NH functional group to be oxidized) were prepared in one of the dropping funnels. A 35 wt % potassium carbonate solution was prepared in the other dropping funnel. The two solutions were introduced simultaneously into the reactor so as to keep the pH of the aqueous phase above 5.8. The strong evolution of CO₂ entirely compensated for the exothermicity of the reaction.

The organic phase rapidly turned a dark red. At the end of the introduction stage, which lasted 1 hour, the mixture was left to return to room temperature, while still keeping the pH at around 5.8. The pH was then raised to 10 in order to remove the last traces of unreacted peracetic acid.

The organic phase was recovered by decanting and the aqueous phase was washed with 400 g of dichloromethane so as to extract the last traces of oxidized CHIMASSORB. The organic phases were collected and the solvent evaporated under reduced pressure. The red polymer obtained was dried in a vacuum oven for 5 hours. The mass of red polymer corresponding to the CHIMASSORB 944® oxidation product was 310 g, i.e. a theoretical yield of 95 mol %.

The scheme below illustrates the above oxidation reaction carried out and having resulted in a multifunctional nitroxide:

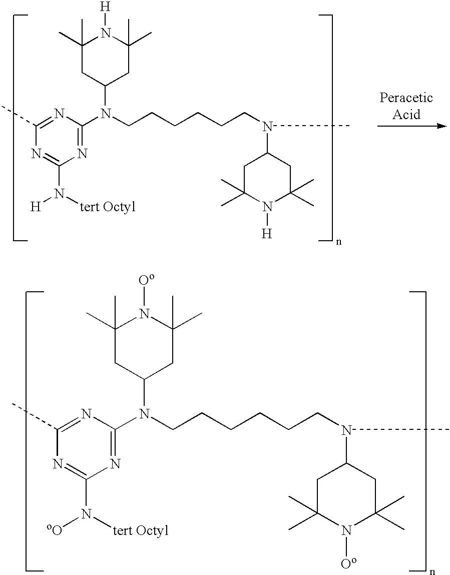

n ranging from 2 to 3. Given that the oxidation of the NH functional groups linked to the tert-octyl groups of the initial amine is partial, it is estimated that each multifunctional nitroxide molecule has from 4 to 9 nitroxide functional groups.

### EXAMPLES 2, 3 AND 4

### Thermoreversible Crosslinking of a Blend of Two Polyethylenes: a High-Density Polyethylene (HDPE) and a Metallocene Polyethylene (ENGAGE 8200 PE)

Table 1 below gives the amounts of the various ingredients. Example 2 is a comparative example and simply represents the blend of the two PEs without any particular treatment except that this blend is extruded. Example 3 is a comparative example in which the two polyethylenes undergo conventional (i.e. peroxide and non-thermoreversible) crosslinking. Example 4 is the crosslinking of the two polyethylenes in the presence of the multifunctional nitroxide produced in Example 1. The operating method for these three examples is identical and is described below:

The blends were introduced into a sealed glass pot together with about 10 g of acetone which made it possible, where appropriate, to dissolve the initiator and the counterradical. The acetone was then evaporated in order to make the blend homogeneous, in the form of granules. The blend was then stirred for 20 minutes in a TERBULA® mixer, again to achieve good homogeneity. The blends were then extruded under the following conditions: on a Haake® counterrotating twin-screw extruder, the temperature profile applied being 170° C.-150° C.-140° C.-135° C. with a screw speed of 100 revolutions per minute. The rod, after cooling in water upon output by the die, was granulated.

For the mechanical (tensile and creep) properties, plaques or test pieces were produced by compression molding. To do this, the granules were firstly converted on a calender (at 160° C. for 10 minutes) so as to obtain homogeneous granules. Next, the plaques and/or test pieces were produced by compression molding at 170° C. These plaques and/or test pieces were then used to measure the mechanical properties.

Example 3 was produced under the following conditions:

n_{A}=0.0034 mol;

f_{A}=4;

n_{A}f_{A}=0.0136 mol;

n_{SFR} between 3.4×10⁻³ and 5.5×10⁻³ mol;

f_{SFR} between 4 and 9;

f_{A}n_{A}f_{SFR}n_{SFR} between 1.377×10⁻² and 4.65×10⁻².

The results are given in Table 1.

TABLE 1

| | | | | | | Melt | Tensile |
|---|---|---|---|---|---|---|---|
| | 2070ML60 | ENGAGE | | Nitro- | | flow | yield stress |
| Ex. | HDPE | 8200 | DHBP | xide | | index | (at 23° C.) |
| No. | (g) | PE (g) | (g) | (g) | f_{A}n_{A}f_{SPR}n_{SFR} | (g/10 min) | (MPa) |
| 2 | 960 | 240 | 0 | 0 | | 6.84 | 11.1 |
| (comp) | | | | | | | |
| 3 | 800 | 200 | 1 | 0 | | 0.15 | 13.8 |
| (comp) | | | | | | | |
| 4 | 800 | 200 | 1 | 10.33 | between 0.3 | 3.69 | 13.8 |
| | | | | | and 1 | | |

The polymer of Example 4 had the same mechanical properties as that of Example 3, and was also thermoreversible, giving it great fluidity when hot (a high melt flow index). The crosslinked resins of Example 3 (comparative example) and Example 4 had on average 0.5 to 1 crosslink per initial polymer chain.

The creep tests showed that the materials of Examples 3 and 4 between them exhibited substantially the same aging resistance and were both substantially superior from this standpoint than that of Example 2.

### EXAMPLES 5, 6 AND 7

### Thermoreversible Crosslinking of a Polyethylene Blend (a HDPE and a Metallocene PE in the Proportion 90/10)

The procedure was as in the case of Examples 2, 3 and 4, but with the compositions indicated in Table 2 below. The results are given in Table 2.

TABLE 2

| | | | | | | Melt | Tensile |
|---|---|---|---|---|---|---|---|
| | 2070ML60 | ENGAGE | | Nitro- | | flow | yield stress |
| Ex. | HDPE | 8200 | DHBP | xide | | index | (at 23° C.) |
| No. | (g) | PE (g) | (g) | (g) | f_{A}n_{A}f_{SPR}n_{SFR} | (g/10 min) | (MPa) |
| 5 | 900 | 100 | 0 | 0 | | 7.18 | 21 |
| (comp) | | | | | | | |
| 6 | 900 | 100 | 1 | 0 | | 0.25 | 22 |
| (comp) | | | | | | | |
| 7 | 900 | 100 | 1 | 10.33 | between 0.3 | 1.38 | 22 |
| | | | | | and 1 | | |

The polymer of Example 7 had the same mechanical properties as that of Example 6 and was also thermoreversible, giving it great fluidity when hot (a high melt flow index).

### EXAMPLE 8

### Preparation of a Multifunctional Nitroxide

The multifunctional nitroxide of the following formula was prepared:

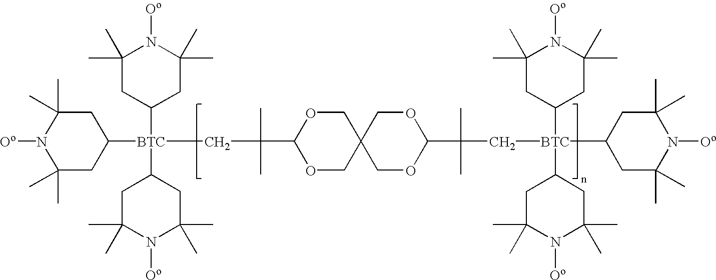

in which BTC is:

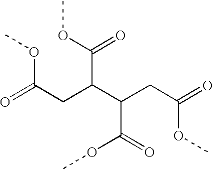

and n is on average 1.5.

To produce this product the starting material was ADK STAB LA 68 from Asahi, the formula of which corresponds to that of the above multifunctional nitroxide, except that the N—O^{o} units were replaced with N—H. The average mass of the ADK SATB LA 68 was 1 900 g/mol, i.e. n=1.5.

50 g of ADK STAB LA 68TM were dissolved in 133 g of dichloromethane. This solution was introduced drop by drop into a water (246 g)/dichloromethane (322 g) two-phase mixture containing 75 g of 40% peracetic acid, the pH of which was raised to 7 by means of a 35 wt % K₂CO₃ solution. During the addition, the pH was kept at this value and the temperature was set to 15° C. Vigorous mechanical stirring was undertaken for a further 1° hour, after the end of the introduction. The mixture gradually became orange-red. When all the peracetic acid had been consumed, the organic phase was recovered by decantating it. The solvent was evaporated under reduced pressure and a friable foam was obtained, which was ground in order to produce a red powder.

The yield was 99 mol % (57 g of multifunctional nitroxide were obtained).

The stoichiometry was calculated as follows:

the average mass of the ADK SATB AL 68 was 1 900 g/mol, i.e. n=1.5 and this product therefore had 7 NH functional groups per mole, i.e. 3.8 millimol of N—H per gram. To oxidize an N—H functional group quantitatively, it is necessary in theory to have 1.5 equivalents of peracetic acid. To compensate for the autodecomposition of the peracetic acid, 2 equivalents of acid per NH functional group were in fact used. The nature of the multifunctional nitroxide was determined by its red color and by the disappearance of the peracetic acid from the reaction mixture.

### EXAMPLES 9 AND 10

### Synthesis of Ethylene Copolymers Crosslinked With and Without Multifunctional Nitroxide

The blends (base polymer, peroxide and, in the case of Example 10, multifunctional nitroxide) were introduced into a sealed glass pot together with in addition about 10 g of acetone which made it possible, where appropriate, to dissolve the initiator and the multifunctional nitroxide. Next, the acetone was evaporated in order to make the blend homogeneous. The blend was then stirred for 20 minutes in a TERBULA® mixer, again in order to achieve good homogeneity. Thus, the base blend (granule or powder) to be extruded was introduced via the feed hopper of the Haake® counterrotating twin-screw extruder, then heated and mixed in the body of the extruder before being recovered in the form of a rod at the die exit, and then granulated. The microextruder was heated electrically in 4 zones (feed, center and exit of the extruder and the die) and controlled by channeling air and water circulating in a jacketed system. The temperature profile applied was 100-170-140-85° C. with a screw speed of 100 revolutions per minute.

| | Mass of | | Mass of | | |
|---|---|---|---|---|---|
| | co- | Mass of | multi- | | Gel |
| | polymer | peroxide | functional | SFR × F_{SFR}/− | content^{a)} |
| Examples | (g) | (g) | nitroxide | AMO × F_{AMO} | (%) |
| 9 | 600 | 12 | 0 | | 12.2 |
| (compar- | | | | | |
| ative) | | | | | |
| 10 | 600 | 12 | 11.1 | 0.5 | 0 |

^{a)}determined at 145° C. by GPC in trichlorobenzene.

### EXAMPLES 11 TO 13

### Preparation of a Hot-Melt Adhesive

66 g of an ethylene/n-butyl acrylate copolymer, 104 g of PERMALYN 6110 resin (rosin ester from Hercules), 30 g of PARAFLINT H₂ wax (Sasol) and 0.4 g of IRGANOX 1010 (antioxidant of formula tetrakis(methylene-[3,5-di-tert-butyl-4-hydroxy)hydrocinnamate]methane) from Ciba-Geigy). The proportions of the ingredients were therefore the following:

33% by weight of base polymer (ethylene/n-butyl acrylate copolymer);

52% by weight of PERMALYN 6110;

15% by weight of PARAFLINT H₂;

0.2% by weight of IRGANOX 1010.

The constituents were melted and blended with stirring at 170° C. for 1 h. In the three examples, a hot-melt adhesive was recovered, this being transparent and homogeneous at 170° C., having a ring-and-ball softening point of 109° C. and possessing the following characteristics:

| | Example 11: | | |
|---|---|---|---|
| | LOTRYL branched | | |
| | with | | |
| | multifunctional | Example 12 | Example 13 |
| Control | nitroxide | (comparative) | (comparative) |
| Base | LOTRYL 35BA320 | LOTRYL 35BA320 | LOTRYL |
| polymer | branched/cross- | branched/ | 35BA320 |
| used | linked thermo- | crosslinked | |
| | reversibly | according to | |
| | according to | Example 9 | |
| | Example 10 | | |
| SAFT | 85° C. | 66° C. | 59° C. |
| temperature | | | |
| under 500 g | | | |
| Brookfield | 1680 | 2700 | 1330 |
| viscosity at | | | |
| 170° C. | | | |
| (mPa · s) | | | |

These results clearly demonstrate that the addition of multifunctional nitroxide allows the temperature 5 cohesion of the hot-melt adhesive to be improved. This is because a much improved SAFT temperature is clearly obtained in the case of Example 11, while still having a low viscosity, compared with the results of Example 12.

1. A process for manufacturing a thermoreversible resin by heat treatment of a polymer in the presence of a multifunctional nitroxide, said treatment extracting protons linked to atoms of the polymer chains so as to graft in their place the nitroxide functional groups of the multifunctional nitroxide in order to form thermoreversible bonds between said atoms and the oxygen atoms of said nitroxide functional groups.

2. The process as claimed in the preceding claim, characterized in that the multifunctional nitroxide has a functionality of at least 3.

3. The process as claimed in the preceding claim, characterized in that the multifunctional nitroxide has a functionality of at least 4.

4. The process as claimed in one of the preceding claims, characterized in that the multifunctional nitroxide has a functionality of at most 50.

5. The process as claimed in the preceding claim, characterized in that the multifunctional nitroxide has a functionality of at most 15.

6. The process as claimed in one of the preceding claims, characterized in that the polymer is a rubber.

7. The process as claimed in one of claims 1 to 5, characterized in that the polymer is a thermoplastic.

8. The process as claimed in one of the preceding claims, characterized in that the polymer has a number-average molecular weight ranging from 1 000 g/mol to 500 000 g/mol.

9. The process as claimed in one of the preceding claims, characterized in that the polymer has a number-average molecular weight ranging from 5 000 to 300 000 g/mol.

10. The process as claimed in one of the preceding claims, characterized in that a free-radical initiator is present, said initiator favoring the extraction of protons from the polymer chains.

11. The process as claimed in the preceding claim, characterized in that the nitroxide and the free-radical initiator are employed in an amount such that (f_{A}n_{A}/f_{SFR}n_{SFR}) is between 0.001 and 30, where:
f_{A} represents the functionality of the free-radical initiator;
n_{A} represents the number of moles of free-radical initiator;
f_{SFR} represents the functionality of the nitroxide; and
n_{SFR} represents the number of moles of nitroxide.

11. The process as claimed in the preceding claim, characterized in that (f_{A}n_{A}/f_{SFR}n_{SFR}) is between 0.01 and 10.

12. The process as claimed in the preceding claim, characterized in that (f_{A}n_{A}/f_{SFR}n_{SFR}) is between 0.1 and 5.

13. The process as claimed in either of claims 10 to 12, characterized in that the free-radical initiator and the multifunctional nitroxide are each present in an amount from 10 ppm by weight to 20% by weight with respect to the weight of the initial polymer to be converted.

14. The process as claimed in the preceding claim, characterized in that the free-radical initiator and the multifunctional nitroxide are each present in an amount from 100 ppm to 5% by weight with respect to the weight of the initial polymer to be converted.

15. The process as claimed in one of the preceding claims, characterized in that the heat treatment is carried out at a temperature ranging from 50 to 250° C.

16. The process as claimed in the preceding claim, characterized in that the heat treatment is carried out in the presence of less than 10% by weight of solvent with respect to the polymer and at a temperature ranging from 180 to 250° C.

17. The process as claimed in the preceding claim, characterized in that the heat treatment is carried out in an extruder.

18. The process as claimed in claim 15, characterized in that the heat treatment is carried out in the presence of solvent and at a temperature ranging from 50 to 150° C.

19. The process as claimed in one of the preceding claims, characterized in that the reaction during the heat treatment is carried out in the absence of monomer, or in the presence of less than 200 ppm of residual monomer.

20. The process as claimed in the preceding claim, characterized in that the atoms of the main chains of the polymer, said atoms contributing to the formation of the thermoreversible bonds, are carbon atoms.

21. The process as claimed in one of the preceding claims, characterized in that the multifunctional nitroxide and, where appropriate, the free-radical initiator are employed in a sufficient amount so that the resin has on average 0.1 to 5 crosslinks per polymer chain.

22. The process as claimed in one of the preceding claims, characterized in that the multifunctional nitroxide has a number-average molecular weight of less than 5 000 g/mol.

23. The process as claimed in one of the preceding claims, characterized in that the polymer is such that proton extraction is followed by crosslinking.

24. The process as claimed in one of the preceding claims, characterized in that the polymer is an ethylene polymer.

25. The process as claimed in one of the preceding claims, characterized in that the polymer is chosen from the following list: an ethylene-acrylate copolymer, an ethylene-vinyl acetate copolymer, a styrene-isoprene-styrene copolymer, a styrene-butadiene-styrene copolymer, a metallocene polyethylene.

26. A. thermoreversible resin whose thermoreversible bonds are, at least in part, X—O bonds forming part of ≡X—O—N═ linking groups when the resin is in the branched or crosslinked state, X representing an atom of a polymer chain, said resin not undergoing debranching or decrosslinking exclusively by the scission of C—O bonds forming part of ≡C—O—N═ linking groups the carbon atom of which belongs to a styrene unit placed at one end of the polymer chain.

27. The thermoreversible resin whose thermoreversible bonds are, at least in part, X—O bonds forming part of ≡X—O—N═ linking groups when the resin is in the branched or crosslinked state, X representing an atom of a polymer chain, the oxygen and nitrogen atoms of said linking groups forming nitroxide functional groups when the resin is in the debranched or decrosslinked state and said nitroxide functional groups defining branching or crosslinking cores not containing a polymerized styrene unit.

28. The resin as claimed in one of the preceding resin claims, characterized in that its thermoreversible bonds are, at least in part, X—O bonds forming part of ≡X—O—N═ linking groups when the resin is in the branched or crosslinked state, X representing an atom of a polymer chain, the oxygen and nitrogen atoms of said linking groups forming nitroxide functional groups when the resin is in the debranched or decrosslinked state and said nitroxide functional groups defining branching or crosslinking cores, said cores comprising at least three nitroxide functional groups when the resin is in the debranched or decrosslinked state.

29. The resin as claimed in claim 27 or 28, characterized in that the cores comprise at least four nitroxide functional groups when the resin is in the debranched or decrosslinked state.

30. The resin as claimed in one of claims 27 to 29, characterized in that the branching or crosslinking cores have a number-average molecular weight of less than 5 000 g/mol.

31. The resin as claimed in one of the preceding resin claims, characterized in that X represents a carbon atom.

32. The resin as claimed in one of the preceding resin claims, characterized in that it has, in the crosslinked state, on average 0.1 to 5 thermoreversible crosslinks per polymer chain.

33. The resin as claimed in one of the preceding resin claims, characterized in that it is not branched or crosslinked by the formation of amide or ester functional groups.

34. The resin as claimed in one of the preceding resin claims, characterized in that the polymer is thermoplastic.

35. The resin as claimed in one of the preceding resin claims, characterized in that the polymer is an ethylene polymer.

36. The resin as claimed in one of claims 26 to 34, characterized in that the polymer is a (meth)acrylate polymer.

37. A hot-melt adhesive comprising a resin of one of claims 26 to 33.

38. The hot-melt adhesive as claimed in the preceding claim, characterized in that the polymer is chosen from the following list: an ethylene-acrylate copolymer, an ethylene-vinyl acetate copolymer, a styrene-isoprene-styrene copolymer, a styrene-butadiene-styrene copolymer, a metallocene polyethylene.

39. The hot-melt adhesive of the preceding claim, characterized in that the polymer is an ethylene-acrylate copolymer, the acrylate being chosen from the following list: methyl acrylate, ethyl acrylate, butyl acrylate and 2-ethylhexyl acrylate.

40. A process for converting the resins of one of the preceding resin claims by injection molding.

41. A process for converting the resins of one of the preceding resin claims by extrusion.
